(19) United States
(12) Patent Application Publication
(10) Pub. No.: US 2005/0102495 A1
(43) Pub. Date: May 12, 2005

(54) Microcomputer apparatus for executing a given instruction a number of times

(76) Inventors: Wei-Hung Huang, Hsin-Chu City (TW); Yao-Huang Hsieh, Hsin-Chu Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/605,951

(22) Filed: Nov. 10, 2003

(51) Int. Cl. G06F 9/00

(52) U.S. Cl. 712/241

(57) ABSTRACT

According to the claimed invention, a microcomputer apparatus is disclosed. The microcomputer apparatus comprises a processing unit for executing instructions and a loop counter coupled to the processing unit for receiving and storing a loop count value according to a loop instruction executed by the processing unit wherein the processing unit decrements the loop count value stored in the loop counter each time an instruction is looped, and when the processing unit encounters a loop instruction, the processing unit will loop the instruction previous to the loop instruction a number of times as defined by the loop count value.

### BACKGROUND OF INVENTION

1. Field of the Invention

The invention relates to a microcomputer apparatus for executing a given instruction a number of times, and more particularly, to a microcomputer apparatus for executing a given instruction a number of times in digital signal processing.

2. Description of the Prior Art

A crucial technology found in a majority of electronics today is DSP Digital Signal Processing. DSP technology basically involves the manipulation of information in digital form, usually converted from an analog form. Manipulating signals digitally offers several advantages over manipulating signals in analog form with the greatest advantage probably being the ability to manipulate signals without degradation.

In order for DSP technology to be useful in most cases, the rate at which signal operations are conducted must be very fast. A high operational rate is essential because most applications today require that the signals be processed in real-time. For example, noise-filtering of a voice signal on a cellular phone is a real-time application. If the operational rate of a DSP chip is too slow, a user would have to wait a certain amount of time before hearing the voice of the person the user is talking to. This result, of course, is unacceptable as people expect to be able to talk in a normal fashion.

Initially, when the idea of DSP technology was first proposed, the goal at the time was to process signals of acceptable sometimes even tolerable quality. As previously mentioned, digital signals received by the DSP are usually transformed from analog signals. The quality of the digital signal is dependent on several factors including things such as how many samples were used to represent the analog signal, how many bits are used to represent each sample, etc. By using digital signals of acceptable quality instead of high quality, the operational rate needed for real-time applications is lowered. However, even by using signals of only acceptable quality, very few processing units of chips at the time could provide a high enough operational rate for real-time applications. Those few processing chips that could accomplish a sufficient operational rate were too large and too expensive to be used in any practical implementation.

The most obvious way to increase the operational rate is to increase the processing speed of the processing unit. Given with Moore's Law the computing power of a chip doubles roughly every 18 months it was a matter of time before cheap and plentiful processing chips of small size providing an adequate operational rate for implementing DSP technology were available. Of course, what followed was the application field for DSP chips exploded, resulting in their use in most electronics today.

However, this did not signal the dismissal of the importance of operational rate. Remember, the first iteration of the implementation of DSP technology was for signals of acceptable quality. By nature, people are concerned with quality and will always strive to improve it with the quality of DSP signals being no exception. As mentioned before, processing higher quality signals requires a higher operational rate. Since a digital signal is nothing more than segments of one continuous analog signal, the quality of a digital signal can always be improved. Hence, the need for improved operational rates will always be present.

The most direct method in increasing the operational rate of a DSP chip is increasing the processing speed of the processing unit. Clearly, a faster processor means that more signal operations can be done within a given time when compare to a slower processor of the same type. The replacement of a slower processor with a faster one is not novel, but simply a given.

Another method in increasing the operational rate of a DSP chip is to take advantage of the nature of DSP technology, specifically, that many of the operations conducted by the DSP chip are repeated. Like any other processing unit, the processing unit of the DSP chip will spend some time on fetching instructions it needs to execute. The presence of a repeated instruction means that the DSP chip will need to fetch the same instruction a number of times in a row. However, fetching the same instruction over and over is redundant. By using hardware to help implement a repeat function, as shown in U.S. Pat. No. 4,713,749 Magar, et al, the instruction needs only to be fetched once, thereby saving time to execute more signal operations and therefore increasing the operational rate of the DSP chip.

Nevertheless, that is not to say that the solution presented by U.S. Pat. No. 4,713,749 Magar, et al is not without fault. U.S. Pat. No. 4,713,749 Magar, et al does help improve the operational rate of the DSP chip, but it is not an optimal method for employing a DSP chip to perform an instruction a number of times in a row. This is because execution of the repeat instruction and the first execution of the instruction to be repeated cannot be done in the same clock cycle but must be done in two. As a result, one clock that could have been used to execute another signal operation is wasted.

### SUMMARY OF INVENTION

It is therefore a primary objective of the claimed invention to provide a dedicated loop counter in the hardware of a microcomputer apparatus to solve the above-mentioned problem.

According to the claimed invention, a microcomputer apparatus is disclosed. The microcomputer apparatus comprises a processing unit for executing instructions and a loop counter coupled to the processing unit for receiving and storing a loop count value according to a loop instruction executed by the processing unit wherein the processing unit decrements the loop count value stored in the loop counter each time an instruction is looped, and when the processing unit encounters a loop instruction, the processing unit will loop the instruction previous to the loop instruction a number of times as defined by the loop count value.

It is advantageous of the present invention to employ dedicated hardware to implement a loop instruction in a microcomputer apparatus to loop the instruction previous to the loop instruction a number of times in a row. Doing so allows the microcomputer apparatus to complete the execution of a given instruction a number of times faster than solution presented by the present art, thereby allowing the microcomputer apparatus to achieve a higher operational rate.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a microcomputer apparatus according to the present invention.

FIG. 2 is a flowchart of operations in the microcomputer apparatus in FIG. 1 according to the present invention.

### DETAILED DESCRIPTION

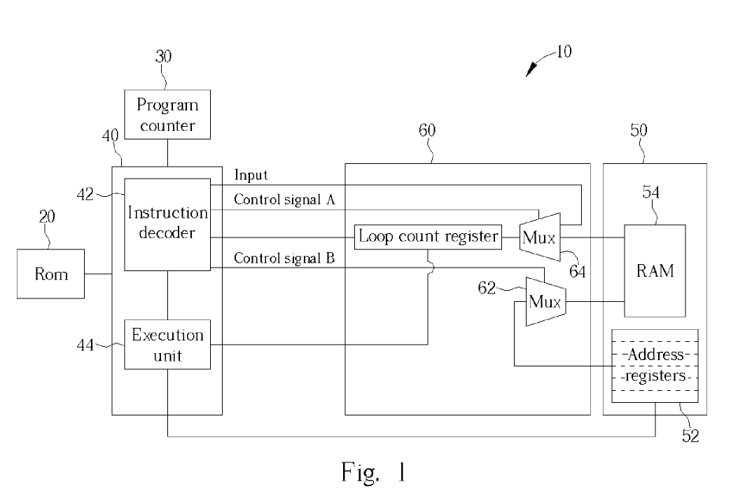

Please refer to FIG. 1. FIG. 1 is a diagram of the preferred embodiment of a microcomputer apparatus according to the present invention. In the preferred embodiment, the microcomputer apparatus 10 comprises a first memory 20, a program counter 30, a processing unit 40, a storage unit 50, and a dedicated loop counter 60.

The first memory 20 is for storing a program that includes a table of the addresses of a plurality of loop count values. The program counter 30 is used by the processing unit 40 as a means of addressing the first memory 20. The processing unit 40 comprises an instruction decoder 42 for decoding and dispatching instructions and checking a loop count value in the dedicated loop counter 60; and an execution unit 44 for executing the dispatched instructions and decrementing the loop count value stored in the dedicated loop counter 60 whenever an instruction is looped. The storage unit 50 comprises a second memory 52 for storing the table in the program stored in the first memory 20 and a third memory 54 for storing a plurality of loop count values corresponding to the addresses contained in the table.

Finally, the dedicated loop counter 60 comprises a first multiplexer 62 for selecting an address of a loop count value from the table stored in the second memory 52 according to a loop instruction decoded by the instruction decoder 42 and sending the address to the third memory 54; a second multiplexer 64 for receiving a loop count value from either the instruction decoder 42 or the third memory 54 and passing the loop count value to a fourth memory 66; and a fourth memory 66 for storing a loop count value received from the second multiplexer 64. The two multiplexers 64, 62 are controlled respectively by Control signal A and Control signal B issued from the instruction decoder 42.

Additionally, in the preferred embodiment of the present invention, the first memory 20 is realized as a ROM (Read Only Memory), the second memory 52 of the storage unit 50 is realized as a set of address registers, the third memory 54 of the storage unit 50 is realized as a RAM (Random Access Memory), and the fourth memory 66 of the dedicated loop counter 60 is realized as a loop count register.

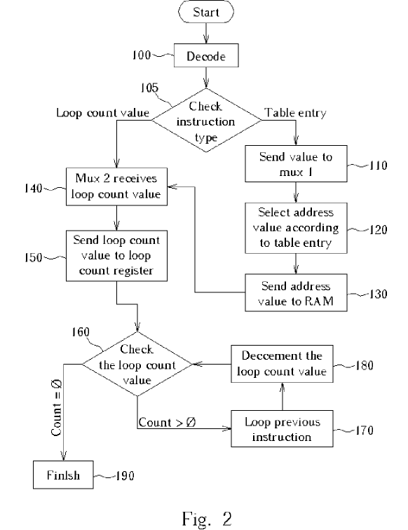

Please refer to FIG. 2. FIG. 2 is a flowchart of the operations in the preferred embodiment of the microcomputer apparatus in FIG. 1 according to the present invention. Prior to the beginning of the flowchart, a table of the addresses of a plurality of loop count values is loaded from the program stored in the ROM 20 into the address registers 52. The flowchart begins with the decoding of a loop instruction in a program stored in the ROM 20. The flowchart ends when the looping has been completed. After the flowchart, the microprocessor apparatus will continue to the next instruction after the loop instruction in the program.

Step 100: Decode the Loop Instruction. The instruction decoder 42 decodes the loop instruction. The loop instruction will either have a loop count value or a table entry coded inside.

Step 105: Check the content of the loop instruction. If a loop count value is present, go to Step 140. If a table entry is present, go to Step 110.

Step 110: Send the table entry to the first multiplexer 62. The instruction decoder 42 issues the table entry in the form of Control signal B.

Step 120: Select an address value according to the table entry. Using Control signal B sent from the instruction decoder 42, the multiplexer 62 retrieves an address value from a table stored in a set of address registers 52.

Step 130: Send the address value to the RAM 54. Once the address is retrieved in Step 120, the first multiplexer 62 sends the address value to the RAM 54.

Step 140: The second multiplexer 64 receives the loop count value. The loop count value can either come from Step 100, where the loop count is sent as an Input signal directly from the instruction decoder 42 to the second multiplexer 64, or from Step 130, where the loop count value is sent from RAM 54 to the second multiplexer 64. The second multiplexer 64 selects the source of the loop count value according to Control signal A issued from the instruction decoder 42.

Step 150: Send the loop count value to the loop count register 66. The second multiplexer 64 will send the loop count value received in Step 140 to the loop count register 66. The loop count value serves to indicate how many loop iterations are left in the loop process.

Step 160: Check the loop count value. The instruction decoder 42 will check the loop count value stored in the loop count register 66. A loop count value greater than 0 signals that the loop process is not yet finished. As a result, go to Step 170. A loop count value of 0 signals that the loop process is finished. As a result, go to Step 190.

Step 170: Loop the previous instruction. Upon determining that the loop count value is greater than 0 in Step 160, the execution unit 44 will execute the instruction prior to the loop instruction. In doing so, one iteration of the loop process is completed.

Step 180: Decrement the loop count value. After having completed one iteration of the loop process in Step 170, the execution unit decrements the loop count value by 1 to represent the completion. After the decrement, return to Step 160.

Step 190: Finish. Since the loop count value was equal to 0 in Step 160, then there are no more iterations left in the loop cycle. In other words, there is no need to repeat the instruction prior to the loop instruction. As a result, the loop cycle is finished, and the processing unit 40 may continue to the next instruction in the program stored in the ROM 20.

To summarize the flowchart of the preferred embodiment of the present invention, the processing unit 40 employs a program counter 30 to address a ROM 20 to execute instructions according to a program stored in the ROM 20. Upon decoding a loop instruction by the instruction decoder 42 of the processing unit 40, the instruction decoder 42 will either send a loop count value directly to the second multiplexer 64 or send a table entry in the form of Control signal B to the first multiplexer 62. The action of the instruction decoder 42 is dependent upon the kind of loop instruction decoded one type has a loop count value embedded while the other has a table entry. Whether the second multiplexer 64 selects a loop count value sent directly from the instruction decoder 42 or selects a loop count value sent indirectly via Control Signal B is determined by Control signal A sent by the instruction decoder 42.

If a loop count value is sent directly to the second multiplexer 64, the second multiplexer will forward the loop count value to the loop count register 66. The instruction decoder will then check the loop count value stored in the loop count register 66. If the loop count value is 0, the processing unit 40 simply moves on to the next instruction.

However, if the loop count value is not 0, the execution unit 44 will execute the instruction prior to the loop instruction and decrement the loop count value by 1. The instruction decoder 42 will then check the loop count value again. The cycle of executing the instruction prior to the loop instruction, decrementing the loop count value, and checking the loop count value will continue until the comparison of the loop count value yields that it is equal to 0. The step after checking the loop count value and finding it is equal to 0 is the same as the above paragraph the processing unit 40 moves on to the next instruction.

In the case that the instruction decoder 42 sends a table entry in the form of Control signal B to the first multiplexer 62 instead of a loop count value to the second multiplexer 64, the first multiplexer 62 will use Control signal B to find an address value from a table stored in a set of address registers 52. Once found, the first multiplexer 62 will forward the address value to the RAM 54. The RAM 54 will then retrieve a loop count value stored at the address value sent from the first multiplexer 62 and send the loop count value to the second multiplexer 64. The steps afterwards are the same as if the second multiplexer 64 received the loop count value from the instruction decoder 42.

By using a dedicated loop counter to implement a loop instruction to execute an instruction a number of times, the microcomputer apparatus is able to complete the execution of an instruction a number of times in a more quickly when compared to using a repeat instruction as shown in U.S. Pat. No. 4,713,749 Magar, et al. The final result is the operational rate of the microcomputer apparatus is improved because by spending less time completing execution of an instruction a number of times, the microcomputer apparatus use the saved time to process other instructions.

The reason the loop counter has a decided advantage is in the very nature of the loop instruction when compared to the repeat instruction. For example, assume there is an instruction named instruction A that needs to be executed 10 times. Using the repeat process, the program would first list a repeat instruction (with a repeat value of 10) followed by instruction A. A processing unit is usually capable of executing more than one instruction in a cycle but of only fetching one instruction in one cycle. When the processing unit encounters the repeat instruction, it knows that instruction A will need to be executed 10 times. But since instruction A comes after the repeat instruction, instruction A will not have been fetched at the execution of the repeat instruction. As just mentioned, a processing unit usually can only fetch one instruction every cycle. As a result, the processing unit in the first cycle can only execute one instruction the repeat instruction. The processing unit then spends 1 cycle for each time instruction A is executed, meaning that a total of 11 cycles are spent to in executing instruction A 10 times.

Using a loop process, the program would list instruction A first followed by a loop instruction (with a loop value of 9). Because instruction A is listed first, the processing unit will have already fetched instruction A before reaching the loop instruction. Consequently, when the processing unit executes the loop instruction in the second cycle, instruction A has already been fetched. As a result, the processing unit in the second cycle can execute both the loop instruction and instruction A. The processing unit then spends 1 cycle for each time instruction A is executed, the same as above. In total, it only takes 10 cycles to execute instruction A 10 times.

Another advantage of the hardware of the present invention when compared to U.S. Pat. No. 4,713,749 Magar, et al is the option of either embedding a loop count value directly into the loop instruction or embedding a table entry which can be used to find a loop count value by using multiplexers. In U.S. Pat. No. 4,713,749 Magar, et al, the only method provided by the hardware is to embed a repeat value into the instruction. The freedom of choice allows the user greater flexibility in design and allows to user to tailor the system to the situation.

In contrast to the prior art, the present invention can accomplish the execution of an instruction a number of times within a shorter amount of time and provide the user greater flexibility in design by employing hardware in a dedicated loop counter so that the performance of the microcomputer apparatus is increased.

Those skilled in the art will readily observe that numerous modifications and alterations of the device may be made while retaining the teachings of the invention. Accordingly, that above disclosure should be construed as limited only by the metes and bounds of the appended claims.

1. A microcomputer apparatus comprising:
a processing unit for executing instructions; and
a loop counter coupled to the processing unit for receiving and storing a loop count value according to a loop instruction executed by the processing unit;
wherein the processing unit decrements the loop count value stored in the loop counter each time an instruction is looped, and when the processing unit encounters a loop instruction, the processing unit will loop the instruction previous to the loop instruction a number of times as defined by the loop count value.

2. The microcomputer apparatus in claim 1 further comprising:
a first memory coupled to the processing unit for storing a program comprising a table containing the addresses of a plurality of loop count values.

3. The microcomputer apparatus in claim 2 wherein the third memory is a ROM (Read Only Memory) memory.

4. The microcomputer apparatus in claim 2 further comprising:
a program counter coupled to the processing unit for addressing the third memory.

5. The microcomputer apparatus in claim 1 wherein the processing unit comprises:
an instruction decoding means for decoding and dispatching instructions for execution and for checking a loop count value stored in the loop counter; and
an execution unit for executing the dispatched instructions and decrementing a loop count value stored in the loop counter.

6. The microcomputer apparatus in claim 1 wherein the loop counter comprises:
a first multiplexer for selecting an address of a loop count value,
a second multiplexer for determining whether a loop count value is being sent from the processing unit or from the address of a loop count value; and
a fourth memory for storing a loop count value and issuing the current state of the loop count value to the processing unit; wherein the processing unit will decrement the loop count value each time an instruction has been looped and will continue looping the instruction until the loop count value has reached 0.

7. The microcomputer apparatus in claim 6 wherein the fourth memory is a loop count register.

8. The microcomputer apparatus in claim 1 wherein the computer apparatus further comprises a storage unit coupled to the processing unit and the loop counter.

9. The microcomputer apparatus in claim 8 wherein the storage unit further comprises:
a second memory coupled to the processing unit and the loop counter for storing a table containing the addresses of a plurality of loop count values; and
a third memory coupled to the loop counter for storing a plurality of loop count values.

10. The microcomputer apparatus in claim 9 wherein the first memory is a set of registers.

11. The microcomputer apparatus in claim 9 wherein the second memory is a RAM (Random Access Memory) memory.
